(19) United States
(12) Patent Application Publication
(10) Pub. No.: US 2008/0163796 A1
(43) Pub. Date: Jul. 10, 2008

(54) Cementitious Materials Including Tobacco Products as Corrosion Inhibitors

(75) Inventors: Joseph A. von Fraunhofer, Parkton, MD (US); Timothy Langan, Catonsville, MD (US); Guy D. Davis, Catonsville, MD (US)

Correspondence Address: PIETRAGALLO GORDON ALFANO BOSICK & RASPANTI LLP, ONE OXFORD CENTRE, 38TH FLOOR, 301 GRANT STREET, PITTSBURGH, PA, 15219-6404, US

(73) Assignee: Inhibitrol, Inc., Parkton, MD (US)

(21) Appl. No.: 11/967,542

(22) Filed: Dec. 31, 2007

Related U.S. Application Data
(60) Provisional application No. 60/883,117, filed on Jan. 2, 2007.

(51) Int. Cl. C04B 7/345

(52) U.S. Cl. 106/802

(57) ABSTRACT

Tobacco products such as dried tobacco leaves, stems and dust are added to cementitious materials in order to inhibit corrosion. In one embodiment, the tobacco additions protect steel embedded in Portland cement from corrosive attack. Tobacco is a renewable, potentially inexpensive bioproduct that provides excellent corrosion protection with little or no environmental concerns.

### CROSS-REFERENCE TO RELATED APPLICATION

This application claims the benefit of U.S. Provisional Application No. 60/883,117 filed Jan. 2, 2007, which is incorporated herein by reference.

### FIELD OF THE INVENTION

The present invention relates to cementitious materials, and more particularly relates to the use of tobacco products in cementitious materials which act as corrosion inhibitors.

### BACKGROUND INFORMATION

Degradation of bridge decks and other reinforced concrete structures predominately involves the corrosion of rebar, which expands and cracks or spalls the concrete surface. Chloride penetration into the concrete and carbonation of pore solutions are leading causes of rebar corrosion. Admixtures of corrosion inhibitors have been used to protect the steel rebar. However, the current additives increase the cost of the concrete and may cause environmental concerns.

Various types of inhibitors have been proposed to protect steel rebar in cement. Researchers at the Virginia Transportation Research Council (B. D. Chambers, S. R. Taylor, and D. S. Lane Final Report: An Evaluation of New Inhibitors for Rebar in Concrete, Va. Transportation Research Council, VTRC 03-R8 Mar. 2003, Charlottesville, Va.) evaluated candidate admixtures designed to prevent corrosion of rebar embedded in Portland cement concrete. They point out that calcium nitrite, the most commonly used admixture to prevent corrosion of rebar in chloride containing environments, acts as an anodic inhibitor protecting the steel by raising the valance state of the iron ions. New inhibitors are required due to the high solubility of calcium nitrite in water and its toxicity. Table 1 from the report by Chambers et al. lists the candidate inhibitors with levels added.

TABLE 1
Candidate inhibitors evaluated by Chambers et. al

| | | Concrete | | Amount per | | | |
|---|---|---|---|---|---|---|---|
| | | Conc. | No. | 0.25 ft³ | | Less H₂O | |
| Chemical Compound | Abbrev. | (mol/ft³) | Samples | Concrete | | in Batch | Source |
| β-glycerophosphate | BGP-1 | 0.815 | 3 | 62.4 | g | 125 ml | Alfa Aesar |
| | BGP-2 | 0.283 | 3 | 21.7 | g | | |
| Control | Co-1 | | 3 | | | | |
| | Co-2 | | 3 | | | | |
| Calcium Nitrite | CN | 0.815 | 4 | 70 | ml | 44.5 ml | WR Grace |
| Lithium Nitrate | LN | 0.815 | 4 | 14.05 | g | | Fisher |
| 2-aminothiophenol | ATP-1 | 0.815 | 4 | 21.8 | ml | | Fluka |
| (99% pure) | ATP-2 | 0.283 | 4 | 7.6 | ml | | |
| | ATP-3 | 2.832 | 4 | 75.8 | ml | | |
| Phosphonic acid | PA | 0.815 | 4 | 30.5 | g AMP | | Fluka |
| | | | | 56 | g zinc salt | | |
| Dibutyl Sulfoxide | DS-1 | 0.815 | 4 | 33.01 | g | | Aldrich |
| | DS-2 | 0.283 | 4 | 11.46 | g | | |
| | DS-3 | 2.832 | 4 | 114.62 | g | | |
| Sodium Metasilicate | NA-1 | 0.815 | 4 | 24.87 | g | | Fluka |
| | NA-2 | 0.283 | 4 | 8.64 | g | | |
| | NA-3 | 2.832 | 4 | 86.36 | g | | |
| Aminoethylethanolamine | AMA-1 | 0.815 | 4 | 20.6 | ml | | Fluka |
| (97% pure) | AMA-2 | 0.283 | 4 | 7.2 | ml | | |
| | AMA-3 | 2.832 | 4 | 71.6 | ml | | |

Note:
This concentration of CN is the lowest recommended dosage without consideration of the chloride content of the concrete. All inhibitors were tested under similar conditions to examine the relative effectiveness.

U.S. Pat. Nos. 5,435,941 and 6,602,555 to von Fraunhofer, which are incorporated herein by reference, disclose tobacco extract solutions, and the use of such solutions as corrosion inhibitors.

The present invention has been developed in view of the foregoing.

### SUMMARY OF THE INVENTION

An embodiment of the present invention relates to the use of tobacco to protect steel embedded in cementitious materials (e.g., Portland cement concrete) from corrosive attack. Tobacco is a renewable, potentially inexpensive bioproduct that provides excellent corrosion protection with little or no environmental concerns. The inhibitor possess favorable properties such as low cost and very low environmental impact and protects steel from aggressive ions in neutral, acidic and alkaline solutions. In one embodiment of the invention, dried and chopped tobacco leaves, stems or dust are added to dry mixes used to fabricate cementitious materials. In another embodiment, dried tobacco extract powder is added to dry mixes used to fabricate cementitious materials.

An aspect of the present invention is to provide a dry cement mixture comprising cement powder and comminuted tobacco.

Another aspect of the present invention is to provide a dry concrete mixture comprising cement powder, sand and/or aggregate, and comminuted tobacco.

A further aspect of the present invention is to provide concrete comprising a reaction product of cement powder, sand and/or aggregate, comminuted tobacco, and water.

An aspect of the present invention is to provide a method of making a dry cement mixture comprising mixing cement powder and comminuted tobacco.

Another aspect of the present invention is to provide a dry cement mixture comprising cement powder and dried tobacco extract powder.

A further aspect of the present invention is to provide a dry concrete mixture comprising cement powder, sand and/or aggregate, and dried tobacco extract powder.

An aspect of the present invention is to provide concrete comprising a reaction product of cement powder, sand and/or aggregate, dried tobacco extract powder, and water.

Another aspect of the present invention is to provide a method of making a dry cement mixture comprising mixing cement powder and dried tobacco extract powder.

These and other aspects of the present invention will be more apparent from the following description.

### DETAILED DESCRIPTION

An aspect of the present invention incorporates comminuted tobacco into cementitious materials. As used herein, the term “comminuted tobacco” means any part of a tobacco plant that has been reduced to particulate form while still maintaining at least a portion of the cellular structure of the plant. Comminuted tobacco may comprise chopped, cut, shredded or otherwise mechanically processed leaves, stems, roots and/or seeds of the tobacco plant. The tobacco plant is typically comminuted before it is mixed with the cementitious material, however, in some embodiments, at least a part of the comminuting process may occur when the tobacco is mixed with the cementitious materials. The tobacco may be provided in raw form, dried form or cured form using conventional tobacco curing techniques. If the tobacco is provided in dried form, it may be mechanically processed before, during or after it is dried. Typical particle sizes of the comminuted tobacco range from about 0.01 micron to about 10 cm, for example, from about 0.1 micron to about 1 cm.

In one embodiment, comminuted tobacco in the form of dried and chopped tobacco leaves are added to conventional dry cement used to fabricate Portland cement concrete. In another embodiment, comminuted tobacco in the form of tobacco dust is added to the dry cement used to fabricate Portland cement concrete. From about 0.01 to about 10 percent by weight of such comminuted tobacco may typically be added to the dry cement. For example, from about 0.05 to about 2 weight percent may be added. As particular examples, 0.1, 0.5 or 1 weight percent of the comminuted tobacco may be added to the dry cement. This mixture may be blended and mixed with conventional types and amounts of sand and/or aggregate to form concrete. Alternatively, the comminuted tobacco may be added to previously mixed dry Portland cement, sand and/or aggregate. Sand typically has a particle size of less than 1 or 2 mm, while aggregate typically has a particle size of greater than 2 mm, for example, greater than 5 mm. The cement typically comprises from about 5 to about 50 weight percent of the total mixture of cement, sand and aggregate, for example, from 10 to 30 weight percent. The sand may comprise up to about 90 weight percent of the total mixture, for example, from about 20 to about 60 weight percent. The aggregate may comprise up to about 90 weight percent of the total mixture, for example, from about 30 to about 80 weight percent. Water may be added to the mixture and the product is poured in place, typically with the inclusion of reinforcing bars.

In another embodiment, the comminuted tobacco is added to conventional dry phosphate or aluminum silicate based cements. From 0.01 to 10 percent by weight of the comminuted tobacco may be added to such types of dry cement. This mixture may be blended and mixed with sand and/or aggregate to form concrete. Alternatively, the comminuted tobacco may be added to previously mixed dry phosphate or aluminum silicate, sand and/or aggregate. Water may be added to the mixture and the product is poured in place, typically with the inclusion of steel reinforcing bars.

In another embodiment, tobacco extract is dried to provide a dried tobacco extract powder that is subsequently added to dry mixes of cements such as Portland, phosphate and aluminum silicate based cements and concrete. As used herein, the term “dried tobacco extract powder” means a solid particulate material formed by introducing raw, dried and/or cured tobacco into a liquid, extracting at least a portion of the organic material of the tobacco plant into the liquid, and separating at least a portion of the extracted organic material from the liquid to form a solid particulate material.

In order to form the dried tobacco extract powder, chopped or otherwise mechanically processed tobacco leaf, stems and/or dust from raw, dried and/or cured tobacco plants may be digested in water having a neutral or acidic pH at a typical ratio of 60-300 g tobacco/1000 ml water for a period of 1-24 hours. Nonpolar solvents such as alkanes, e.g., hexane, may optionally be used in order to remove nonpolar organic compounds from the tobacco. In this case, the nonpolar solvent treatment may be performed prior to the water extraction process. The cellulosic tobacco residue is filtered off and can be discarded or used for other applications such as a source of biofuel, backfill, fertilizer, etc. The supernatant liquor from the extraction process may typically contain 1 to 7 percent dissolved solids, depending upon the type of tobacco, the tobacco/water ratio, the extraction conditions, e.g., static or stirred, water temperature and digestion time of tobacco in water. The extraction liquor may be concentrated by digesting more tobacco into the liquor or may be subjected to evaporative or other drying processes to remove excess water. Suitable drying techniques include evaporation by static or circulating air techniques at ambient or elevated temperatures, spray drying, freeze drying, vortex drying, critical point drying and the like. If excess water is removed by evaporation, low heat should be used to avoid thermal decomposition of organic components within the extract liquor. The resultant dried tobacco extract powder may then be added to cement and concrete mixes of the types and in the amounts described above. The dried tobacco extract powder typically has an average particle size of from about 0.01 micron to about 5 mm.

The following example is intended to illustrate various aspects of the present invention, and is not intended to limit the scope of the invention.

### EXAMPLE 1

Dried chopped leaves of tobacco are added to conventional Portland cement powder in amounts of 0.1, 0.5 and 1 weight percent of the dry weight of the cement. The dry mixture of cement powder and comminuted tobacco is mixed with C33 sand and limestone aggregate at a cement to sand to aggregate weight ratio of approximately 1 to 2 to 3. Water is then added at a water to cement ratio of 0.5. The wet mixture is cast into coupons and cured.

Whereas particular embodiments of this invention have been described above for purposes of illustration, it will be evident to those skilled in the art that numerous variations of the details of the present invention may be made without departing from the invention as defined in the appended claims.

1. A dry cement mixture comprising:
cement powder; and
comminuted tobacco.

2. The dry cement mixture of claim 1, wherein the comminuted tobacco comprises from about 0.01 to about 10 weight percent of the mixture.

3. The dry cement mixture of claim 1, wherein the comminuted tobacco comprises from about 0.05 to about 2 weight percent of the mixture.

4. The dry cement mixture of claim 1, wherein the comminuted tobacco comprises chopped tobacco leaves.

5. The dry cement mixture of claim 1, wherein the comminuted tobacco comprises raw tobacco.

6. The dry cement mixture of claim 1, wherein the comminuted tobacco comprises dried tobacco.

7. The dry cement mixture of claim 1, wherein the comminuted tobacco comprises cured tobacco.

8. The dry cement mixture of claim 1, wherein the comminuted tobacco has an average particle size of from about 0.01 micron to about 10 cm.

9. The dry cement mixture of claim 1, wherein the cement powder comprises Portland cement.

10. The dry cement mixture of claim 1, wherein the cement powder comprises phosphate cement.

11. The dry cement mixture of claim 1, wherein the cement powder comprises aluminum silicate cement.

12. A dry concrete mixture comprising:
cement powder;
sand and/or aggregate; and
comminuted tobacco.

13. The dry concrete mixture of claim 12, wherein the cement comprises from about 5 to about 50 weight percent, the sand comprises from zero to about 90 weight percent, and the aggregate comprises from zero to about 90 weight percent of the total dry concrete mixture.

14. Concrete comprising a reaction product of:
cement powder;
sand and/or aggregate;
comminuted tobacco; and
water.

15. A method of making a dry cement mixture comprising mixing cement powder and comminuted tobacco.

16. The method of claim 15, further comprising adding sand and/or aggregate to the mixture.

17. The method of claim 16, further comprising adding water to the mixture.

18. A dry cement mixture comprising:
cement powder; and
dried tobacco extract powder.

19. The dry cement mixture of claim 18, wherein the dried tobacco extract powder comprises from about 0.01 to about 10 weight percent of the mixture.

20. The dry cement mixture of claim 18, wherein the dried tobacco extract powder has an average particle size of from about 0.01 micron to about 5 mm.

21. A dry concrete mixture comprising:
cement powder;
sand and/or aggregate; and
dried tobacco extract powder.

22. Concrete comprising a reaction product of:
cement powder;
sand and/or aggregate;
dried tobacco extract powder; and
water.

23. A method of making a dry cement mixture comprising mixing cement powder and dried tobacco extract powder.

24. The method of claim 23, further comprising adding sand and/or aggregate to the mixture.

25. The method of claim 24, further comprising adding water to the mixture.
